(19) United States
(12) Patent Application Publication
(10) Pub. No.: US 2010/0242024 A1
(43) Pub. Date: Sep. 23, 2010

(54) User Interface System and Method for Controlling Conversion of a Source Job Control Language File into a Test Job Control Language File

(76) Inventor: Jesus Orlando Gonzales, II, Foster City, CA (US)

Correspondence Address: AFS/ VISA, 666 THIRD AVENUE , 10TH FLOOR, NEW YORK, NY, 10017, US

(21) Appl. No.: 12/405,823

(22) Filed: Mar. 17, 2009

(51) Int. Cl. G06F 9/44

(52) U.S. Cl. 717/125; 715/764; 718/100

(57) ABSTRACT

A user interface system for interactively controlling conversion of a source JCL into a test JCL for execution in a test environment is provided. The system includes a memory storing the source JCL containing program codes and an instruction file for converting the source JCL into the test JCL according to the test environment. A user interface module executable by a processor displays a plurality of jobs to be executed in the test environment and receives a user selection of one or more of the displayed jobs for conversion of the user selected jobs into the test JCL according to the stored instruction file.

### FIELD OF THE INVENTION

The present invention relates to data processing and, in particular, relates to a user interface system for controlling generation of job control language (JCL) files in test bed computing environments.

### BACKGROUND OF THE INVENTION

Making modifications or enhancements to software running in a live computer system requires careful testing and deployment, especially if the system is a large transaction processing system such as VisaNet™, which processes over one hundred million financial transactions (e.g., credit card transactions) per day. Typically, a set of software modification projects are initially tested in a test environment which emulates the actual transaction processing system.

Mainframe computer systems are typically employed to process such a large volume of transaction data. Instructional code for mainframe computers is implemented using Job Control Language (JCL) code. In JCL, a set of code instructions for performing a particular task is referred to as a ‘job’. During testing operations, one or more jobs may be added, removed or modified to test the performance of the mainframe using the altered instructions. Through such changes, source JCL, including a set of jobs in an ‘initial’ state are converted into test JCL, including a set of jobs modified so as to execute a specified test.

Testers have had little control over this process in that it has been difficult to review the individual changes made to the jobs and also difficult to make changes to jobs ‘on the fly’ to adjust the test environment. These shortcomings have made it difficult for the tester to control the generation of test JCL for a test environment.

It would therefore be desirable to provide a user interface for testers which provide greater control over generation of test JCL for execution in a test environment.

### SUMMARY OF THE INVENTION

According to one aspect, the present invention provides a user interface system for controlling conversion of a source JCL into a test JCL for execution in a test environment. The user interface system includes a memory storing the source JCL containing program codes and an instruction file for converting the source JCL into the test JCL according to the test environment, a processor and a user interface module executable by the processor. The user interface module is adapted to display a plurality of jobs to be executed in the test environment and receive a user selection of one or more of the displayed jobs for conversion of the user selected jobs into the test JCL according to the stored instruction file.

According to a second aspect, the present invention provides a method for controlling, using a computer user interface, conversion of a source JCL stored in a computer memory into a test JCL for execution in a test environment based on an instruction file. The method includes displaying a plurality of jobs to be executed in the test environment through the user interface and receiving a user selection of one or more of the displayed jobs for conversion of the user selected jobs into the test JCL according to the instruction file through the user interface.

### BRIEF DESCRIPTION OF THE DRAWINGS

FIG. 1 is a block diagram of an exemplary computer system for implementing the user interface for controlling generation of JCLs according to an embodiment of the present invention.

FIG. 2 is a schematic diagram of a design of the user interface for controlling generation of JCLs according to an embodiment of the present invention.

FIG. 3 is an exemplary display image of the main panel of the user interface according to an embodiment of the present invention.

FIG. 4 is an exemplary display image of the job list panel of the user interface according to an embodiment of the present invention.

FIG. 5 is an exemplary display image of the flow panel of the user interface according to an embodiment of the present invention.

FIG. 6 is an exemplary display image of a job edit screen of the user interface according to an embodiment of the present invention.

### DETAILED DESCRIPTION OF THE INVENTION

For purposes of this application, the terms “code”, “program”, “application”, “software code”, “software module”, “module” and “software program” are used interchangeably to mean software instructions that are executable by a processor.

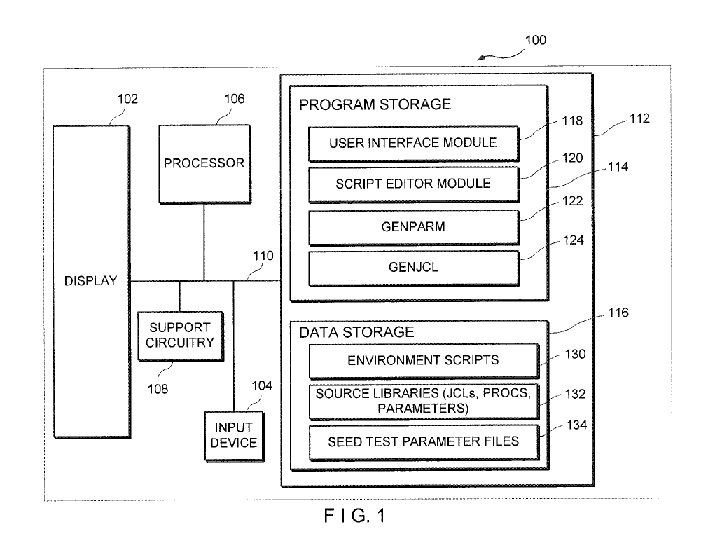

An exemplary block diagram of a computer system 100 that may be used to implement the user interface system according to an embodiment of the present invention is shown in FIG. 1. Computer system 100 includes a display 102, an input device 104 such as a keyboard, mouse or pointer, a processor 106, such as a central processing unit (CPU), and support circuitry 108. The display 102, an input device 104, processor 106, and support circuitry 108 are commonly connected to a bus 110 which also connects to a memory 112. Memory 112 includes program storage memory 114 and data storage memory 116.

Program storage memory 114 and data storage memory 116 may each comprise volatile (RAM) and non-volatile (ROM) memory units and may also comprise hard disk and backup storage capacity. Program storage memory 114 stores software program modules and associated data, and in particular stores a user interface module 118 according to the present invention. In some embodiments, program storage memory 114 also stores a text editor module 120, and certain programs GENPARM 122 and GENJCL 124 used for generating test JCLs as explained further below. User interface module 118 is adapted to generate a user interface on the display 102 into which a user such as a software tester may enter selections via input devices 104. As described below in greater detail, user interface module 118 displays, through the user interface, a plurality of jobs to be executed in the test environment and receives a user selection of one or more of the displayed jobs for conversion of the user selected jobs into the test JCL (among other functions). Data storage memory 116 stores environment script instruction files 130 which include instructions for setting up the test environment, source files 132 including jobs (‘source JCLs’), procedures (procs) and parameters in their initial ‘source’ state prior to modification to meet the requirements of the test environment. Data storage memory 116 also includes seed test parameter files 134 also used to set up parameters for the test environment. The source files 132 may be located in various data sources within data storage memory 116, such as libraries used in the quality assurance (QA) stage of testing, as well as production copies of such JCLs, procs, and parameter files.

It is to be appreciated that the computer system 100 may be any computer such as a personal computer, minicomputer, workstation, mainframe, or a combination thereof. While the computer system 100 is shown, for illustration purposes, as a single computer unit, the system may comprise a group/farm of computers which can be scaled depending on the processing load and database size.

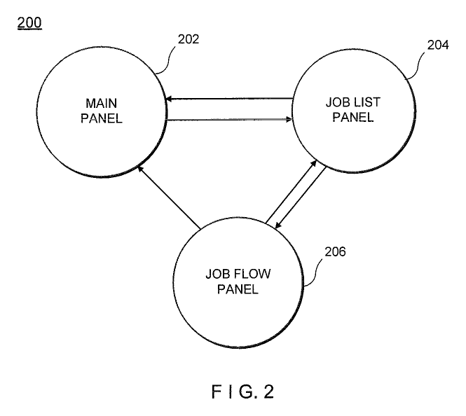

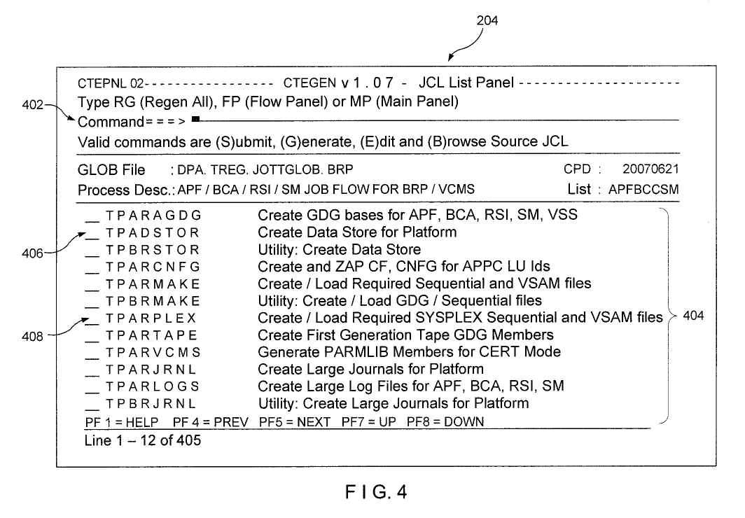

FIG. 2 is a schematic diagram of a design of a user interface 200 used to control generation of test JCLs according to an embodiment of the present invention. The user interface 200 includes a main panel 202, a job list panel 204 and a job flow panel 206. The main panel allows the user to enter an identifier of an instruction file 130 corresponding to a particular test environment. The instruction file 130 includes a list of the jobs (shown in FIG. 4) that are to be executed in the test environment. From the main panel, the job list panel 204 may be accessed. The job list panel displays the list of jobs to be executed in the test environment contained in the instruction file 130, and allows the user to select one of more of the listed jobs for further processing as discussed below with respect to FIG. 4. From the job list panel, the user may enter a command to return to the main panel 202, or may enter an alternative command to reach the job flow panel 206. The job flow panel 206 displays the list of jobs in the order in which they are to be executed in the test environment. From the job flow panel 206, the user may enter commands to return to either the main panel 202 or the job list panel 204.

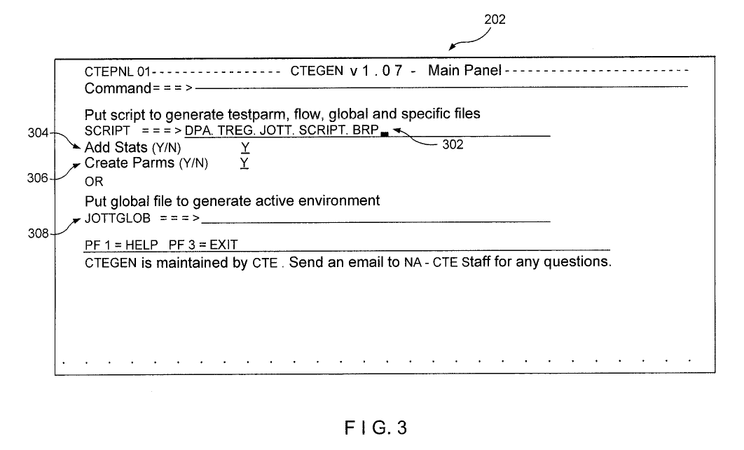

FIG. 3 is an exemplary display image of the main panel 202 of user interface 200 according to an embodiment of the present invention. As shown, the main panel 202 contains a SCRIPT entry line 302 into which the user may enter the identifier of the instruction file 130 which is commonly referred to as the ‘environment script’. In the example shown, the instruction file identifier ‘DPA.TREG.JOTT.SCRIPT.BRP’ has been entered into SCRIPT entry line 302. When an identifier has been entered as shown, the user interface module 118 calls the GENPARM program 122 which uses the instruction file to create an intermediary set of files including a GLOBAL file (also referred to as JOTTGLOB), a SPECIFIC file, and a FLOW file. The GLOBAL file contains a list of all jobs to be executed in the test environment and also contains modifications such as reference name overrides which apply to all of the jobs to be executed. The SPECIFIC file contains modifications that apply to a specified subset of the jobs to be executed, and the FLOW file contains a schedule indicating an appropriate order in which to execute the jobs.

Main panel 202 allows the user to specify certain features via the Add Stats command line 304 and the Create Parms command line 306. Through the Add Stats command line 304, the user may choose (Yes or No) whether to add member statistics in the library (JCLs, procs, parameters) of the source files 132, such as the dates that the members were created, the dates the members were last modified and the identities of the tester(s) that last modified the members. The default of this option is typically set to “No” (N). Through the Create Parms command line 306, the user may choose (Yes or No) whether GENPARM 122 should generate an environment test parameter file (in addition to the GLOBAL, SPECIFIC and FLOW files) containing certain parameter values that are used to configure the test environment. If the instruction file 130 or any parameters have been updated in a manner that will affect the environment test parameters, then this option is set to Yes (Y).

If GENPARM 122 has already been previously executed using an instruction file 130, and a corresponding GLOBAL file has been generated, the user may enter an identifier of the GLOBAL file instead of an instruction file identifier in the JOTTGLOB entry command line 308. After the user enters an identifier of either the instruction file 130 or the GLOBAL file, user interface module 118 automatically generates and displays the job list panel 204.

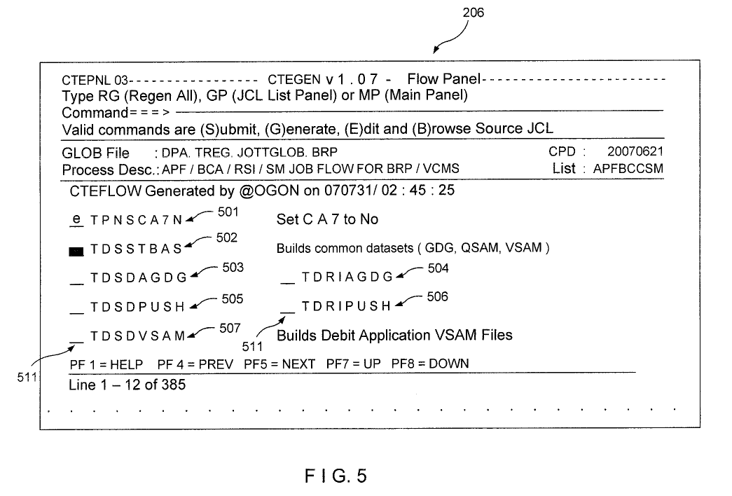

An exemplary display image of the job list panel 204 is shown in FIG. 4. As shown, the job list panel 204 includes a main command line 402 which runs horizontally near the top of the main panel 202 and a list of all of the jobs to be executed 404 which user interface module 118 generates by extracting the list of jobs included in the GLOBAL file. Through the main command line 402, the user may type “RG” to generate test JCL for all of the listed jobs, “MP” to return to the main panel 202, or “FP” to switch over to the flow panel 206 described with reference to FIG. 5 below.

The list of jobs 404 is more precisely a list of the names of the jobs that are to be executed, with one job name listed per line. It is to be understood that the twelve job names displayed in FIG. 4 are only a subset of the entire list of jobs to be executed, as indicated on the bottom of the list where it is provided that only lines 1-12 out of 418 lines are displayed. Adjacent to each of the job names in the list 404 is a command line (e.g., 406, 408) in which the user may enter one of the command options “G” to generate test JCL, “S” to submit for execution, “E” to edit test JCL, or “B” to review source JCL. The use of the per-job command lines 406, 408 allow the user to set commands for individual jobs instead of for the entire list of jobs. For example, when the user enters “RG” in the main command line, user interface module 118 calls the GENJCL program 124 which uses the source files 132 in combination with the modifications instructions in the GLOBAL, SPECIFIC, FLOW obtained from instruction file 130 to generate test JCLs for all of the jobs in the list 404 according to the test environment. However, if the user is aware, for example, that only the jobs ‘TPADSTOR’ and ‘TPARPLEX’ have been updated, instead of generating test JCLs for the entire list of jobs via the command “RG”, the user can instead generate test JCLs according to the test environment (by calling GENJCL) solely for the two modified jobs by entering the generate command “G” on command lines 406 and 408. This feature can save considerable time, since the GENJCL program 124 only converts the selected jobs for which test JCLs need to be generated to create the test environment. Similarly, the individual job command lines 406, 408 allow the user to submit individual jobs for execution using the submit command, to edit the test JCL code of individual jobs, or to browse the source JCL code of individual jobs.

An exemplary display image of a flow panel 206 of the user interface 200 is shown in FIG. 5. The flow panel 206 displays a list of jobs in the linear order in which they are to be executed as obtained from the FLOW file. In the depicted flow panel 206, the first 7 jobs 501-507 to be executed are shown in their prescribed order. Thus, job 501 is scheduled to be executed first, and job 502 is scheduled to be executed second. Jobs 503 and 504 are on the same line, and therefore the user can choose which of the jobs to submit before the other, or can submit them simultaneously; likewise for jobs 505, 506. However, according to the schedule, both of jobs 503, 504 are scheduled to be executed before either of jobs 505, 506. Job 507 is scheduled to be executed after jobs 505, 506. By allowing the user to submit jobs in the flow panel individually and in a step-wise manner, the user can wait to determine whether a job executes successfully before submitting a subsequent job; if a job does not execute successfully, the user can locate the source of the error.

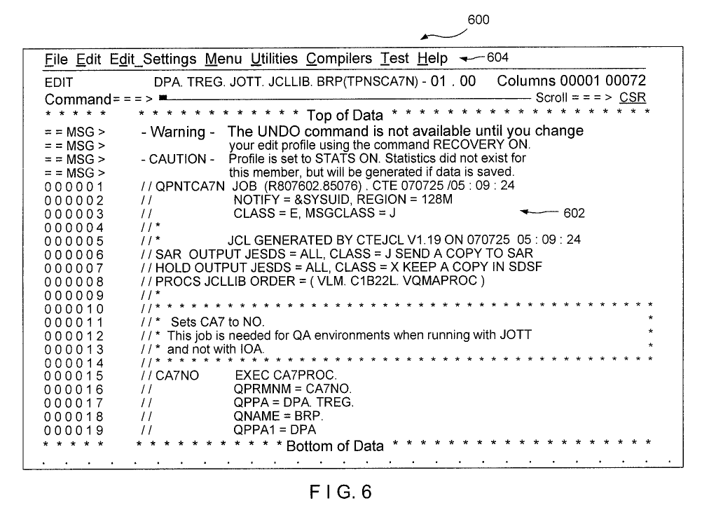

The command lines 511-517 shown adjacent to the respective job names 501-507 allow the user to enter individual commands in the manner discussed with respect to the job list panel 204 of FIG. 4. In particular, individual jobs can be generated, submitted, edited and reviewed from the flow panel 206. As shown in FIG. 5, an “e” has been entered in command line 511, which causes user interface module to retrieve the test JCL for job 501 (if job 501 has been generated, otherwise the test JCL for job 501 is generated first, and then test JCL is retrieved), and to execute a text editor module 120 which displays the program code of the test JCL for 501 in editable form. FIG. 6 is a display image of a job edit screen 600 including the test JCL code 602 of job ‘QPNTCA7N’ which corresponds to job 501 ‘TPNSCA7N’ (shown in FIG. 5) with the first and fourth letters changed to indicate that the job has been converted into test JCL. The menu of commands 604 allows the user to employ features of the text editor module 120 to modify the test JCL within the edit screen 600. The browse command “B”, invokes a viewing screen in which the source JCL of a selected job may be viewed. In the case of the browse command, editing functions are disabled since it is generally the best practice to avoid direct modifications to the source files.

The user interface system of the present invention provides a number of useful features for testing operations. By providing the user the ability to select only those jobs that have been updated for generation into test JCLs, the user interface system saves a substantial amount of processing time. Furthermore, by allowing the user a convenient way to retrieve and edit test JCLs, review source JCLs, and test execution of individual jobs through the flow panel, the user interface provides the user with the tools and utilities to discover and debug errors, and make appropriate adjustments.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A user interface system for controlling conversion of a source JCL into a test JCL for execution in a test environment, comprising:
a memory storing the source JCL containing program codes and an instruction file for converting the source JCL into the test JCL according to the test environment;
a processor coupled to the memory; and
a user interface module executable by the processor and adapted to:
display a plurality of jobs to be executed in the test environment; and
receive a user selection of one or more of the displayed jobs for conversion of the source JCL of the user selected jobs into the test JCL according to the stored instruction file.

2. The user interface system of claim 1, wherein based on user input, the user interface module calls one or more programs to convert the user selected jobs into the test JCL.

3. The user interface system of claim 1, wherein the user interface module:
receives an identification of the instruction file from the user; and
calls a first program to generate, based on the user identified instruction file:
a global file indicating modifications applicable to all of the plurality of jobs to be executed in the test environment,
a specific file indicating modifications to a subset of the plurality of jobs to be executed in the test environment, and
a flow file indicating an order in which the plurality of jobs to are be executed in the test environment.

4. The user interface system of claim 3, wherein the user interface module is adapted to display a sequential order in which the plurality of jobs in the test JCL are to be executed based on the flow file.

5. The user interface system of claim 4, wherein the user interface module is adapted to receive input from the user to selectively execute one or more of the jobs that are displayed in sequential order.

6. The user interface system of claim 1, wherein based on user input, the user interface module calls a text editor to enable on-screen user modification of one or more user selected jobs in the test JCL.

7. The user interface system of claim 1, wherein based on user input, the user interface module calls a browser to display one or more user selected jobs in the source JCL for review by the user.

8. The user interface system of claim 3, wherein based on user input, the user interface module calls a second program to convert the user selected jobs into the test JCL based on the global file, the specific file, and the flow file.

9. The user interface system of claim 1, wherein the user interface module is adapted to generate:
a first display panel into which a user identification of the instruction file is entered;
a second display panel that:
displays the plurality of jobs to be executed in the test environment;
receives user selection of one or more of the displayed jobs;
calls one or more programs to convert the source JCL of the user selected jobs into the test JCL; and
a third display panel that displays a sequential order in which the plurality of jobs in the test JCL are to be executed.

10. A user interface system for controlling conversion of a source JCL into a test JCL for execution in a test environment, comprising:
a memory storing the source JCL containing program codes and an instruction file for converting the source JCL into the test JCL according to the test environment;
a processor; and
a user interface module executable by the processor and adapted to:
display a plurality of jobs to be executed in the test environment; and
receive a user selection of one or more of the displayed jobs for conversion of the user selected jobs into the test JCL according to the stored instruction file; and
call one or more programs to convert the stored source JCL of the user selected jobs into a partial or a complete test JCL according to the instruction file.

11. The user interface system of claim 10, wherein the user interface module:
receives an identification of the instruction file from the user; and
calls a first program to generate, based on the user identified instruction file:
a global file indicating modifications applicable to all of the plurality of jobs to be executed in the test environment,
a specific file indicating modifications to a subset of the plurality of jobs to be executed in the test environment, and
a flow file indicating an order in which the plurality of jobs to are be executed in the test environment.

12. The user interface system of claim 11, wherein the user interface module is adapted to display a sequential order in which the plurality of jobs in the test JCL are to be executed based on the flow file.

13. A method for controlling, using a computer user interface, conversion of a source JCL stored in a computer memory JCL into a test JCL for execution in a test environment based on an instruction file, the method comprising:
displaying in a display device a plurality of jobs to be executed in the test environment through the computer user interface; and
receiving through the computer user interface a user selection of one or more of the displayed jobs for conversion of the source JCL of the user selected jobs into the test JCL according to the instruction file.

14. The method of claim 13, further comprising:
calling one or more programs to convert the user selected jobs into the test JCL based on user input.

15. The method of claim 13, further comprising:
receiving an identification of the instruction file through the computer user interface; and
calling a first program to generate, based on the user identified instruction file:
a global file indicating modifications applicable to all of the plurality of jobs to be executed in the test environment,
a specific file indicating modifications to a subset of the plurality of jobs to be executed in the test environment, and
a flow file indicating an order in which the plurality of jobs to are be executed in the test environment.

16. The method of claim 15, further comprising:
displaying in the display device a sequential order in which the plurality of jobs in the test JCL are to be executed based on the flow file.

17. The method of claim 16, further comprising:
receiving input from the user to selectively execute one or more of the jobs that are displayed in sequential order through the computer user interface.

18. The method of claim 13, further comprising:
calling, based on user input, a text editor to enable user modification of one or more user selected jobs in the test JCL through the computer user interface.

19. The method of claim 13, further comprising:
calling, based on user input, a browser to display one or more user selected jobs in the source JCL for review by the user through the computer user interface.

20. The method of claim 15, further comprising:
calling, based on user input, a second program to convert the user selected jobs into the test JCL based on the global file, the specific file, and the flow file.

21. The method of claim 13, further comprising:
generating a first display panel of the computer user interface into which a user identification of the instruction file is entered;
generating a second display panel of the computer user interface that:
displays the plurality of jobs to be executed in the test environment;
receives user selection of one or more of the displayed jobs;
calls one or more programs to convert the source JCL of the user selected jobs into the test JCL; and
generating a third display panel of the computer user interface that displays a sequential order in which the plurality of jobs in the test JCL are to be executed.
